(19) United States
(12) Patent Application Publication
(10) Pub. No.: US 2025/0187071 A1
(43) Pub. Date: Jun. 12, 2025

(54) MULTI-PRINCIPAL ELEMENT ALLOY (MPEA) NANOPARTICLES

(71) Applicant: The Johns Hopkins University, Baltimore, MD (US)

(72) Inventors: Chao WANG, Baltimore, MD (US); Fei Xu, Baltimore, MD (US)

(21) Appl. No.: 19/053,564

(22) Filed: Feb. 14, 2025

Related U.S. Application Data
(63) Continuation of application No. PCT/US2023/072266, filed on Aug. 16, 2023.
(60) Provisional application No. 63/371,568, filed on Aug. 16, 2022.

(51) Int. Cl. B22F 1/054; B22F 9/24; C22C 5/04; C25B 11/081; C25B 11/089; H01M 4/90

(52) U.S. Cl. CPC B22F 1/054; B22F 9/24; C22C 5/04; C25B 11/081; C25B 11/089; H01M 4/9058; B22F 2301/25; B22F 2304/05; B22F 2998/10; B22F 2999/00

(57) ABSTRACT

The present disclosure relates to multi-principal element alloy (MPEA) nanoparticles and the synthesis of said MPEA nanoparticles in organic solutions. The present disclosure also relates to catalysts comprising the MPEA nanoparticles for use, for example, in fuel cells and water electrolyzers.

### CROSS-REFERENCE TO RELATED APPLICATIONS

This application claims the benefit of U.S. Provisional Application No. 63/371,568, filed Aug. 16, 2022, the contents of which are incorporated herein by reference in their entirety.

### FIELD

The present disclosure relates to multi-principal element alloy (MPEA) nanoparticles and the synthesis of said MPEA nanoparticles in organic solutions. The present disclosure also relates to catalysts comprising the MPEA nanoparticles for use in fuel cells and water electrolyzers.

### BACKGROUND

Multi-principal element alloys (MPEAs) are materials comprising four or more metallic elements, the constituents of which uniformly distribute in a single-phase solid solution. MPEAs can include high-entropy alloys (HEA), which comprise five or more metallic elements. Due to some superior mechanical properties and catalytical activities they exhibit, MPEAs and HEAs have been widely applied in catalysis, especially electrocatalysis [1]-[4]. Their enhanced performances are usually attributed to the high entropy stabilizing effect, synergy effect, and strain effect. The thermodynamic basic equation ΔGₘᵢₓ=ΔHₘᵢₓ−TΔSₘᵢₓ could explain the entropy stabilization, when the TΔSₘᵢₓ overcomes ΔHₘᵢₓ and dominates the ΔGₘᵢₓ, the alloy would show superior stability. Therefore, with the addition of a new element into the MPEA, the system entropy will be increased, along with the corresponding augmentation in material stability. Another important fact derived from the thermodynamic relationship is that high temperature is a key parameter favoring the formation of high entropy alloys [2]-[3].

High entropy alloys have been used in various electrocatalysis reactions, among which oxygen reduction reactions (ORR) are the most challenging ones due to the sluggish kinetics and harsh reaction environment [5]. The surprising stability and complex surface constitution suggest that MPEAs and HEAs have the potential to be practicable catalysts for ORR.

Disadvantageously, many synthesized MPEAs and HEAs of the prior art have been manufactured as bulk solids, which have not demonstrated superior catalytic properties relative to noble-metal based catalysts. There is significant interest in the use of MPEA and HEA nanoparticles, which have a larger surface area with higher catalytic activity, relative to the bulk MPEAs and HEAs, but manufacturing the MPEA or HEA nanoparticles has proved challenging.

Towards that end, a method of synthesizing MPEA nanoparticles using an organic solution is disclosed herein. The as-synthesized MPEA nanoparticles have a substantially uniform size distribution and a substantially uniform elemental distribution throughout the nanoparticles. Further, the MPEA nanoparticles exhibit enhanced catalytic activity for electrochemical oxygen reduction reactions and show great promise for use in fuel cells and water electrolyzers.

### SUMMARY

In one aspect, a method of synthesizing multi-principal element alloy (MPEA) nanoparticles (NPs) is described, said method comprising:
combining at least four metal ion-containing compounds in at least one first solvent and heating to a first temperature in a range from about 100° C. to about 150° C., preferably about 110° C. to about 130° C., in an inert environment for time effective to dissolve the metal ion-containing compounds in the first solvent to produce a mixture comprising metal ions;
adding at least one reducing agent to the mixture and heating to a second temperature in a range from about 250° C. to about 350° C., preferably about 280° C. to about 320° C., for time effective to substantially complete reduction of the metal ions; and
cooling to a third temperature in a range from about 15° C. to about 25° C. and mixing with at least one second solvent to obtain a mixture comprising the MPEA NPs,
wherein the at least four metal ion-containing compounds comprise an element selected from the group consisting of Pt, Ti, V, Cr, Mn, Fe, Co, Ni, Cu, Zn, Zr, Nb, Mo, Tc, Ru, Rh, Pd, Ag, Cd, Hf, Ta, W, Re, Os, Ir, and Au.

In yet another aspect, a method of synthesizing multi-principal element alloy (MPEA) nanoparticles (NPs) is described, said method comprising:
combining at least four metal ion-containing compounds in at least one first solvent and heating to a first temperature in a range from about 100° C. to about 150° C., preferably about 110° C. to about 130° C., in an inert environment for time effective to dissolve the metal ion-containing compounds in the first solvent to produce a mixture comprising metal ions;
adding at least one reducing agent to the mixture and heating to a second temperature in a range from about 250° C. to about 350° C., preferably about 280° C. to about 320° C., for time effective to substantially complete reduction of the metal ions; and
cooling to a third temperature in a range from about 15° C. to about 25° C. and mixing with at least one second solvent to obtain a mixture comprising the MPEA NPs,
wherein the at least four metal ion-containing compounds are selected from the group consisting of a platinum ion-containing compound, an iron ion-containing compound, a cobalt ion-containing compound, a nickel ion-containing compound, a copper ion-containing compound, and an iridium ion-containing compound.

In another aspect, a method of synthesizing Pt-based multi-principal element alloy (MPEA) nanoparticles (NPs) is described, said method comprising:
combining at least four metal ion-containing compounds in at least one first solvent and heating to a first temperature in a range from about 100° C. to about 150° C., preferably about 110° C. to about 130° C., in an inert environment for time effective to dissolve the metal ion-containing compounds in the first solvent to produce a mixture comprising metal ions;
adding at least one reducing agent to the mixture and heating to a second temperature in a range from about 250° C. to about 350° C., preferably about 280° C. to about 320° C., for time effective to substantially complete reduction of the metal ions; and
cooling to a third temperature in a range from about 15° C. to about 25° C. and mixing with at least one second solvent to obtain a mixture comprising the Pt-based MPEA NPs,
wherein the at least four metal ion-containing compounds comprise a Pt ion-containing compound plus at least three other metal ion-containing compounds selected from the group consisting of an iron ion-containing compound, a cobalt ion-containing compound, a nickel ion-containing compound, a copper ion-containing compound, and an iridium ion-containing compound.

In yet another aspect, a multi-principal element alloy (MPEA) nanoparticle comprising, consisting essentially of, or consisting of, four or more elements selected from the group consisting of Pt, Ti, V, Cr, Mn, Fe, Co, Ni, Cu, Zn, Zr, Nb, Mo, Tc, Ru, Rh, Pd, Ag, Cd, Hf, Ta, W, Re, Os, Ir, and Au, is described.

In another aspect, a multi-principal element alloy (MPEA) nanoparticle comprising, consisting essentially of, or consisting of, four or more elements selected from the group consisting of Pt, Fe, Co, Ni, Cu, and Ir, is described.

In still another aspect, a multi-principal element alloy (MPEA) nanoparticle comprising, consisting essentially of, or consisting of, Pt plus three or more additional elements selected from the group consisting of Fe, Co, Ni, Cu, and Ir, is described.

In yet another aspect, a catalyst material comprising a MPEA nanoparticle described herein is disclosed.

In still another aspect, an electrode for a fuel cell or a water electrolyzer, including a catalyst material comprising a MPEA nanoparticle described herein is disclosed.

In another aspect, a fuel cell, a water electrolyzer, a regenerative fuel cell, or a reversible water electrolyzer, wherein the fuel cell, water electrolyzer, regenerative fuel cell, or reversible water electrolyzer comprises an ion exchange membrane which is coated on at least on one side with a catalyst material, wherein the catalyst material comprises a MPEA nanoparticle described herein is disclosed.

Other aspects, features and embodiments of the invention will be more fully apparent from the ensuing disclosure and appended claims.

### BRIEF DESCRIPTION OF THE DRAWINGS

FIG. 1A provides two different HRTEM images corresponding to the (111) planes of face-centered cubic Pt.

FIG. 1B provides two different HRTEM images corresponding to Pt₄FeCoNiCu MPEA nanoparticles.

FIG. 1C provides two different HRTEM images corresponding to Pt₅IrFeCoNiCu MPEA nanoparticles.

FIG. 2A is an EDS map showing the composition of Pt₄FeCoNiCu MPEA nanoparticles.

FIG. 2B is an EDS map showing the composition of Pt₅IrFeCoNiCu MPEA nanoparticles.

FIG. 3 illustrates the XRD patterns of Pt relative to Pt₄FeCoNiCu and Pt₅IrFeCoNiCu MPEA nanoparticles.

FIG. 4A is lower magnification BF STEM and ADF STEM of Pt₄FeCoNiCu MPEA nanoparticles.

FIG. 4B is lower magnification BF STEM and ADF STEM of Pt₅IrFeCoNiCu MPEA nanoparticles.

FIG. 4C is higher magnification BF STEM and ADF STEM of Pt₅IrFeCoNiCu MPEA nanoparticles.

FIG. 5 summarizes the percentage of Pt, Fe, Co, Ni, Cu, and Ir (when present) in the MPEA NPs prepared herein, as determined using STEM EDX, ICP, and HRTEM EDX.

### DETAILED DESCRIPTION

Unless otherwise defined, all technical and scientific terms used herein have the same meaning as commonly understood by one of ordinary skill in the art. In case of conflict, the present document, including definitions, will control. Preferred methods and materials are described below, although methods and materials similar or equivalent to those described herein can be used in practice or testing of the present disclosure. All publications, patent applications, patents, and other references mentioned herein are incorporated by reference in their entirety. The materials, methods, and examples disclosed herein are illustrative only and not intended to be limiting.

For purposes of this disclosure, the chemical elements are identified in accordance with the Periodic Table of the Elements, CAS version, Handbook of Chemistry and Physics, 75^{th} Ed., inside cover, and specific functional groups are generally defined as described therein. Additionally, general principles of organic chemistry, as well as specific functional moieties and reactivity, are described in Sorrell, Organic Chemistry, 2^{nd} edition, University Science Books, Sausalito, 2006; Smith, March's Advanced Organic Chemistry: Reactions, Mechanism, and Structure, 7^{th} Edition, John Wiley & Sons, Inc., New York, 2013; Larock, Comprehensive Organic Transformations, 3^{rd} Edition, John Wiley & Sons, Inc., New York, 2018; and Carruthers, Some Modern Methods of Organic Synthesis, 3^{rd} Edition, Cambridge University Press, Cambridge, 1987; the entire contents of each of which are incorporated herein by reference.

“Substantially devoid” is defined herein to mean that none of the indicated substance is intentionally added or present. For example, less than about 1 wt %, preferably less than about 0.1 wt %, and even more preferably less than about 0.01 wt % of the indicated substance is present.

“About” and “approximately” are used to provide flexibility to a numerical range endpoint by providing that a given value may be “slightly above” or “slightly below” the endpoint without affecting the desired result, for example, +/−5%.

The phrase “in one embodiment” or “in some embodiments” as used herein does not necessarily refer to the same embodiment, though it may. Furthermore, the phrase “in another embodiment” as used herein does not necessarily refer to a different embodiment, although it may. Thus, as described below, various embodiments of the invention may be readily combined, without departing from the scope or spirit of the invention.

The terms “comprise(s),” “include(s),” “having,” “has,” “can,” “contain(s),” and variants thereof, as used herein, are intended to be open-ended transitional phrases, terms, or words that do not preclude the possibility of additional acts or structures. The singular forms “a,” “and” and “the” include plural references unless the context clearly dictates otherwise. The present disclosure also contemplates other embodiments “comprising,” “consisting of” and “consisting essentially of,” the embodiments or elements presented herein, whether explicitly set forth or not.

As defined herein, “high-entropy alloys” (HEAs) are alloys containing 5 or more constituent elements. As defined herein, “multi-principal element alloys” (MPEAs) are similar to HEAs but may include as few as four constituent elements. The defining feature of HEAs and MPEAs over other complex alloys is that, due to their high entropy of mixing, they essentially consist of a simple solid solution phase, rather than forming one or more intermetallic phases. Various HEAs and MPEAs exhibit one or more superior mechanical properties such as yield strength, fracture toughness, and fatigue resistance. For ease of reference, hereinafter, all alloy nanoparticles described herein will be referred to as MPEAs, since HEAs are encompassed by the definition for MPEA. It should be appreciated that all HEAs are MPEAs, but not all MPEAs are HEAs. In one embodiment, the constituent elements in the MPEAs described herein are substantially homogeneously distributed or dispersed in the MPEA nanoparticles.

As defined herein, “Pt-based high-entropy alloys” and “Pt-based multi-principal element alloys” correspond to Pt-based HEAs and Pt-based MPEAs, respectively, comprising at least about 20 mol % Pt, based on the total number of moles of metal in the alloy. In some embodiments, the HEAs and MPEAs comprise at least about 33 mol % Pt, based on the total number of moles of metal in the alloy. In some embodiments, the HEAs and MPEAs comprise at least about 40 mol % Pt, based on the total number of moles of metal in the alloy. In some embodiments, the HEAs and MPEAs comprise at least about 50 mol % Pt, based on the total number of moles of metal in the alloy. In some embodiments, the HEAs and MPEAs comprise at least about 60 mol % Pt, based on the total number of moles of metal in the alloy. In some embodiments, the remaining mol % of the non-Pt metal elements in the alloy can be distributed substantially equally among the other non-Pt metal elements. In some embodiments, the remaining mol % of the non-Pt metal elements in the alloy are not distributed equally among the other non-Pt metal elements.

As defined herein, “nanoparticles” have an effective mean diameter in a range from about 0.1 nm to about 250 nm. In some embodiments, the effective mean diameter of the nanoparticles is in a range from about 0.1 nm to about 100 nm. In some embodiments, the effective mean diameter of the nanoparticles is in a range from about 0.5 nm to about 100 nm. In some embodiments, the effective mean diameter of the nanoparticles is in a range from about 0.5 nm to about 20 nm. In some embodiments, the effective mean diameter of the nanoparticles is in a range from about 1 nm to about 20 nm. In some embodiments, the effective mean diameter of the nanoparticles is in a range from about 20 nm to about 50 nm. In some embodiments, the effective mean diameter of the nanoparticles is in a range from about 50 nm to about 100 nm. In some embodiments, the nanoparticles have a narrow size distribution, for example, in a range of about 1-5 nm. In some embodiments, the nanoparticles have a wide size distribution, for example, in a range of about 5-20 nm or more.

As defined herein, a “substantially uniform elemental distribution throughout the MPEA nanoparticle” corresponds to the substantially homogeneous distribution or dispersion of the constituent metal element throughout the nanoparticle. In other words, the concentration of one metal anywhere in the interior of the nanoparticle is substantially identical to the concentration of said metal at or on the surface.

As defined herein, “substantially equally” is about ±3%.

It is well known that the “precious” metals include Au, Ag, Ru, Rh, Os, Ir, Pt, Pd, and optionally Re. In some embodiments, the precious metals include Au, Pt, and Pd. In some embodiments, the precious metals include Ag. In some embodiments, the precious metals include Ru. In some embodiments, the precious metals include Rh. In some embodiments, the precious metals include Os. In some embodiments, the precious metals include Ir. In some embodiments, the precious metals include Re. Accordingly, for the purposes of the present application, the “non-precious” metals include Ti, V, Cr, Mn, Fe, Co, Ni, Cu, Zn, Zr, Nb, Mo, Tc, Cd, Hf, Ta, W, and optionally Re.

The present disclosure relates to high-temperature organic phase monodisperse MPEA nanoparticles, e.g., Pt-based MPEA nanoparticles, a method of synthesizing said high-temperature organic phase monodisperse MPEA nanoparticles in an organic solution, and a method of using said high-temperature organic phase monodisperse MPEA nanoparticles as a catalyst, for example, for oxygen reduction in oxygen reduction reactions, e.g., in a fuel cell. As used herein, fuel cells include, but are not limited to, polymer electrolyte fuel cells, a membrane electrode assembly, and a polymer electrolyte fuel cell.

Various embodiments of the invention fabricate and utilize MPEAs comprising, consisting essentially of, or consisting of, four or more elements including Pt, Ti, V, Cr, Mn, Fe, Co, Ni, Cu, Zn, Zr, Nb, Mo, Tc, Ru, Rh, Pd, Ag, Cd, Hf, Ta, W, Re, Os, Ir, and/or Au. In various embodiments, Pt-based MPEAs comprising, consisting essentially of, or consisting of, Pt plus three or more additional elements including Ti, V, Cr, Mn, Fe, Co, Ni, Cu, Zn, Zr, Nb, Mo, Tc, Ru, Rh, Pd, Ag, Cd, Hf, Ta, W, Re, Os, Ir, and/or Au are described herein. In various embodiments, Pt-based MPEAs comprising, consisting essentially of, or consisting of, Pt plus three or more additional elements including Fe, Co, Ni, Cu, and/or Ir are described herein. In some embodiments, Pt-based MPEAs comprising, consisting essentially of, or consisting of, Pt plus four or more additional elements including Fe, Co, Ni, Cu, and/or Ir are described herein. Exemplary MPEAs in accordance with embodiments of the invention include Pt₄FeCoNiCu and Pt₅IrFeCoNiCu. The MPEAs described herein are single-phase solid solutions and are useful as catalysts, for example in oxygen reduction reactions.

In a first aspect, a method of synthesizing multi-principal element alloy (MPEA) nanoparticles (NPs), said method comprising:
combining at least four metal ion-containing compounds in at least one first solvent and heating to a first temperature in a range from about 100° C. to about 150° C., preferably about 110° C. to about 130° C., in an inert environment for time effective to dissolve the metal ion-containing compounds in the first solvent to produce a mixture comprising metal ions;
adding at least one reducing agent to the mixture and heating to a second temperature in a range from about 250° C. to about 350° C., preferably about 280° C. to about 320° C., for time effective to substantially complete reduction of the metal ions; and
cooling to a third temperature in a range from about 15° C. to about 25° C. and mixing with at least one second solvent to obtain a mixture comprising the MPEA NPs,
wherein the at least four metal ion-containing compounds comprise an element selected from the group consisting of Pt, Ti, V, Cr, Mn, Fe, Co, Ni, Cu, Zn, Zr, Nb, Mo, Tc, Ru, Rh, Pd, Ag, Cd, Hf, Ta, W, Re, Os, Ir, and Au.

In some embodiments of the first aspect, a method of synthesizing multi-principal element alloy (MPEA) nanoparticles (NPs) is described, said method comprising:
combining at least four metal ion-containing compounds in at least one first solvent and heating to a first temperature in a range from about 100° C. to about 150° C., preferably about 110° C. to about 130° C., in an inert environment for time effective to dissolve the metal ion-containing compounds in the first solvent to produce a mixture comprising metal ions;
adding at least one reducing agent to the mixture and heating to a second temperature in a range from about 250° C. to about 350° C., preferably about 280° C. to about 320° C., for time effective to substantially complete reduction of the metal ions; and
cooling to a third temperature in a range from about 15° C. to about 25° C. and mixing with at least one second solvent to obtain a mixture comprising the MPEA NPs,
wherein the at least four metal ion-containing compounds are selected from the group consisting of a platinum-containing compound, an iron ion-containing compound, a cobalt ion-containing compound, a nickel ion-containing compound, a copper ion-containing compound, and an iridium ion-containing compound.

In some embodiments of the first aspect, a method of synthesizing Pt-based multi-principal element alloy (MPEA) nanoparticles (NPs) is described, said method comprising:
combining at least four metal ion-containing compounds in at least one first solvent and heating to a first temperature in a range from about 100° C. to about 150° C., preferably about 110° C. to about 130° C., in an inert environment for time effective to dissolve the metal ion-containing compounds in the first solvent to produce a mixture comprising metal ions;
adding at least one reducing agent to the mixture and heating to a second temperature in a range from about 250° C. to about 350° C., preferably about 280° C. to about 320° C., for time effective to substantially complete reduction of the metal ions; and
cooling to a third temperature in a range from about 15° C. to about 25° C. and mixing with at least one second solvent to obtain a mixture comprising the Pt-based MPEA NPs,
wherein the at least four metal ion-containing compounds comprise a Pt ion-containing compound plus at least three other metal ion-containing compounds selected from the group consisting of an iron ion-containing compound, a cobalt ion-containing compound, a nickel ion-containing compound, a copper ion-containing compound, and an iridium ion-containing compound.

Advantageously, unlike the MPEA NPs synthesis methods of the prior art, the method of the first aspect can be performed at lower temperatures (e.g., less than about 400° C.) and as such does not require special equipment.

The first solvents for use in the method of the first aspect include, but are not limited to, long-chain alkylamines having at least sixteen carbon atoms such as olelyamine, octadecylamine, hexadecylamine, linoleylamine, arachidonoyl amine, and methylarachidonoyl amine. In some embodiments, the first solvent comprises olelyamine, which advantageously acts as a surfactant, a solvent, and an additional reducing agent.

The second solvents for use in the method of the first aspect include, but are not limited to, tetramethylene sulfone, benzyl ether, 1-octadecene, dichlorobenzene, trichlorobenzene; straight-chained or branched C₁-C₆ alcohols including, but not limited to, methanol, ethanol, 1-propanol, 2-propanol, 1-butanol, 2-butanol, t-butanol, 1-pentanol, and hexanol; glycols such as ethylene glycol, propylene glycol (1,2-propanediol), tetramethylene glycol (1,4-butanediol) and neopentyl glycol; or glycol ethers such as diethylene glycol monomethyl ether, triethylene glycol monomethyl ether, diethylene glycol monoethyl ether, triethylene glycol monoethyl ether, ethylene glycol monopropyl ether, ethylene glycol monobutyl ether, diethylene glycol monobutyl ether, triethylene glycol monobutyl ether, propylene glycol methyl ether, dipropylene glycol methyl ether, tripropylene glycol methyl ether, propylene glycol n-propyl ether, dipropylene glycol n-propyl ether, tripropylene glycol n-propyl ether, propylene glycol n-butyl ether, dipropylene glycol n-butyl ether, and tripropylene glycol n-butyl ether; dimethylacetamide; formamide; dimethylformamide; 1-methyl-2-pyrrolidinone; dimethyl sulfoxide; and any combination thereof. Combinations of two or more second solvent species are also contemplated herein. In some embodiments, the second solvent comprises ethanol.

The reducing agents for use in the method of the first aspect include, but are not limited to, borane-tert-butylamine complex (BTB), ascorbic acid, n-butyl lithium, super hydride solution, NaBH4, carbon monoxide, hydrogen gas, and carbonyl chemicals. The reducing agent can be dissolved in at least one nonpolar solvent prior to addition to the mixture. In some embodiments, the nonpolar solvent used to dissolve the at least one reducing agent comprises olelyamine, which advantageously acts as a surfactant, a solvent, and an additional reducing agent.

The metal-ion containing compounds comprise at least one metal cation and at least one anion, wherein the metal cation is selected from including Pt, Ti, V, Cr, Mn, Fe, Co, Ni, Cu, Zn, Zr, Nb, Mo, Tc, Ru, Rh, Pd, Ag, Cd, Hf, Ta, W, Re, Os, Ir, and/or Au, and the anion is selected from the group consisting of fluoride, chloride, bromide, iodide, nitrite, nitrate, sulfite, sulfate, chlorite, chlorate, cyanide, hydroxide, oxide, sulfide, phosphate, acetate, carbonate, bicarbonate, nitride, oxalate, ethylenediamine tetraacetate, thiocyanate, acetylacetonate, catecholate, cyclopentadienyl, dimethylglyoximate, glycinate, and carbonyl. In some embodiments, the anions of the four or more metal-ion containing compounds used in the method of making the MPEA are identical. In some embodiments, the four or more metal-ion containing compounds used in the method of making the MPEA include at least two different anions. In some embodiments, the four or more metal-ion containing compounds used in the method of making the MPEA include at least three different anions. In some embodiments, each of the four or more metal-ion containing compounds used in the method of making the MPEA include a different anion. In some embodiments, at least one metal-ion containing compound comprises an acetylacetonate anion. In some embodiments, at least one metal-ion containing compound comprises a non-precious metal. In some embodiments, at least one of the metal ion-containing compounds is a Pt-containing compound. In some embodiments, at least 20 mol % of a Pt-containing compound, relative to the total number of moles of metal-ion containing compounds, is dissolved in the first solvent. In some embodiments, at least 33 mol % or 40 mol % or 50 mol % or 60 mol % of a Pt-containing compound, relative to the total number of moles of metal-ion containing compounds, is dissolved in the first solvent. In some embodiments, the metal-ion containing compounds used include Pt-containing compounds, Fe-containing compounds, Co-containing compounds, Ni-containing compounds, Cu-containing compounds, and optionally Ir-containing compounds.

In some embodiments, the inert environment comprises argon, nitrogen, and combinations thereof.

In some embodiments, the time needed to dissolve the metal ion-containing compounds in the first solvent at the first temperature is in a range from about 10 min to about 90 min, preferably about 20 min to about 60 min, and more preferably in a range from about 20 min to about 40 min. In some embodiments, the time needed to substantially complete reduction of the metal ions at the second temperature is in a range from about 30 min to about 240 min, preferably about 45 min to about 90 min, and more preferably about 45 min to about 75 min.

In some embodiments, the method of the first aspect can further comprise separating the synthesized MPEA nanoparticles from the second solvent, e.g., using centrifugation, and washing the synthesized MPEA nanoparticles using a washing solution. In some embodiments, the washing solution comprises hexane, ethanol, or a mixture of hexane and methanol. After washing, the synthesized MPEA nanoparticles can be dispersed in hexane.

In some embodiments of the first aspect, a method of synthesizing multi-principal element alloy (MPEA) nanoparticles (NPs) is described, said method comprising:
combining at least four metal ion-containing compounds in oleylamine and heating to a first temperature in a range from about 100° C. to about 150° C., preferably about 110° C. to about 130° C., in an inert environment for time effective to dissolve the metal ion-containing compounds in oleylamine to produce a mixture comprising metal ions;
adding borane-tert-butylamine complex to the mixture and heating to a second temperature in a range from about 250° C. to about 350° C., preferably about 280° C. to about 320° C., for time effective for substantially complete reduction of the metal ions; and
cooling to a third temperature in a range from about 15° C. to about 25° C. and mixing with at least one second solvent to obtain a mixture comprising the MPEA NPs,
wherein the at least four metal ion-containing compounds comprise an element selected from the group consisting of Pt, Ti, V, Cr, Mn, Fe, Co, Ni, Cu, Zn, Zr, Nb, Mo, Tc, Ru, Rh, Pd, Ag, Cd, Hf, Ta, W, Re, Os, Ir, and Au.

In some embodiments, at least one metal-ion containing compound comprises an acetylacetonate anion. In some embodiments, at least one of the metal ion-containing compounds is a Pt-containing compound. In some embodiments, at least 20 mol % of a Pt-containing compound, relative to the total number of moles of metal-ion containing compounds, is dissolved in the oleylamine. In some embodiments, at least one of the metal ion-containing compounds is a Pt-containing compound. In some embodiments, at least 33 mol % or 40 mol % or 50 mol % or 60 mol % of a Pt-containing compound, relative to the total number of moles of metal-ion containing compounds, is dissolved in the oleylamine. In some embodiments, the metal-ion containing compounds used include a Pt-containing compound, a Fe-containing compound, a Co-containing compound, a Ni-containing compound, a Cu-containing compound, and optionally an Ir-containing compound, as described herein. In some embodiments, the second solvent comprises ethanol.

In some embodiments of the first aspect, a method of synthesizing multi-principal element alloy (MPEA) nanoparticles (NPs) is described, said method comprising:
combining at least four metal ion-containing compounds in oleylamine and heating to a first temperature in a range from about 100° C. to about 150° C., preferably about 110° C. to about 130° C., in an inert environment for time effective to dissolve the metal ion-containing compounds in oleylamine to produce a mixture comprising metal ions;
adding borane-tert-butylamine complex to the mixture and heating to a second temperature in a range from about 250° C. to about 350° C., preferably about 280° C. to about 320° C., for time effective for substantially complete reduction of the metal ions; and
cooling to a third temperature in a range from about 15° C. to about 25° C. and mixing with at least one second solvent to obtain a mixture comprising the MPEA NPs,
wherein the at least four metal ion-containing compounds are selected from the group consisting of a platinum-containing compound, an iron ion-containing compound, a cobalt ion-containing compound, a nickel ion-containing compound, a copper ion-containing compound, and an iridium ion-containing compound.

In some embodiments, at least one metal-ion containing compound comprises an acetylacetonate anion. In some embodiments, at least one of the metal ion-containing compounds is a Pt-containing compound. In some embodiments, at least 20 mol % of a Pt-containing compound, relative to the total number of moles of metal-ion containing compounds, is dissolved in the oleylamine. In some embodiments, at least 33 mol % or 40 mol % or 50 mol % or 60 mol % of a Pt-containing compound, relative to the total number of moles of metal-ion containing compounds, is dissolved in the oleylamine. In some embodiments, the metal-ion containing compounds used include a Pt-containing compound, a Fe-containing compound, a Co-containing compound, a Ni-containing compound, a Cu-containing compound, and optionally an Ir-containing compound, as described herein. In some embodiments, the second solvent comprises ethanol.

In some embodiments of the first aspect, a method of synthesizing Pt-based multi-principal element alloy (MPEA) nanoparticles (NPs) is described, said method comprising:
combining at least four metal ion-containing compounds in at least one first solvent and heating to a first temperature in a range from about 100° C. to about 150° C., preferably about 110° C. to about 130° C., in an inert environment for time effective to dissolve the metal ion-containing compounds in a first solvent to produce a mixture comprising metal ions;
adding at least one reducing agent to the mixture and heating to a second temperature in a range from about 250° C. to about 350° C., preferably about 280° C. to about 320° C., for time effective for substantially complete reduction of the metal ions; and
cooling to a third temperature in a range from about 15° C. to about 25° C. and mixing with at least one second solvent to obtain a mixture comprising the Pt-based MPEA NPs,
wherein the at least four metal ion-containing compounds comprise a Pt ion-containing compound, a Fe-containing compound, a Co-containing compound, a Ni-containing compound, a Cu-containing compound, and optionally an Ir-containing compound.

In some embodiments, at least one metal-ion containing compound comprises an acetylacetonate anion. In some embodiments, at least 20 mol % of the Pt-containing compound, relative to the total number of moles of metal-ion containing compounds, is dissolved in the first solvent. In some embodiments, at least at least 33 mol % or 40 mol % or 50 mol % or 60 mol % of the Pt-containing compound, relative to the total number of moles of metal-ion containing compounds, is dissolved in the first solvent. In some embodiments, the first solvent comprises oleylamine. In some embodiments, the reducing agent comprises borane-tert-butylamine complex. In some embodiments, the second solvent comprises ethanol.

In some embodiments, the MPEA NPs synthesized using the method of the first aspect are single-phase solid solutions, have a substantially uniform nanoparticle size, a narrow size distribution, and a substantially uniform elemental distribution throughout the MPEA nanoparticle. In some embodiments, the MPEA NPs have an increased specific surface area, relative to Pt NPs, and also exhibit enhanced catalytic activity, for example, for electrochemical oxygen reduction reactions. It should be appreciated by the person skilled in the art, that the methods of the first aspect to synthesize MPEA nanoparticles do not utilize a ball milling process, a cryo-milling process, a dealloying process, or carbothermal shock, as is common in the prior art.

In a second aspect, a multi-principal element alloy (MPEA) nanoparticle is described, said MPEA nanoparticle comprising, consisting essentially of, or consisting of, four or more elements selected from the group consisting of Pt, Ti, V, Cr, Mn, Fe, Co, Ni, Cu, Zn, Zr, Nb, Mo, Tc, Ru, Rh, Pd, Ag, Cd, Hf, Ta, W, Re, Os, Ir, and Au. In some embodiments, at least one of the metal elements is a Pt. In some embodiments, the MPEA nanoparticle comprises at least 20 mol % Pt, relative to the total number of moles of metals in the MPEA nanoparticle. In some embodiments, the MPEA nanoparticle comprises at least at least 33 mol % or 40 mol % or 50 mol % or 60 mol % Pt, relative to the total number of moles of metals in the MPEA nanoparticle. In some embodiments, the remaining mol % of the non-Pt metals in the MPEA is distributed substantially equally among the additional elements. In some embodiment, the remaining mol % of the non-Pt metals in the MPEA are not distributed equally among the additional elements. The MPEA NP is a single-phase solid solution, having a substantially uniform nanoparticle size and a substantially uniform elemental distribution throughout the MPEA nanoparticle. The MPEA NPs have an increased specific surface area, relative to Pt NPs, and also exhibit enhanced catalytic activity for electrochemical oxygen reduction reactions.

In some embodiments of the second aspect, a multi-principal element alloy (MPEA) nanoparticle is described, said MPEA nanoparticle comprising, consisting essentially of, or consisting of, Pt plus three or more additional elements selected from the group consisting of Fe, Co, Ni, Cu, and Ir. In some embodiments, the MPEA nanoparticle comprises at least 20 mol % Pt, relative to the total number of moles of metals in the MPEA nanoparticle. In some embodiments, the MPEA nanoparticle comprises at least at least 33 mol % or 40 mol % or 50 mol % or 60 mol % Pt, relative to the total number of moles of metals in the MPEA nanoparticle. In some embodiments, the remaining mol % of the non-Pt metals in the MPEA is distributed substantially equally among the additional elements. In some embodiments, the remaining mol % of the non-Pt metals in the MPEA are not distributed equally among the additional elements. The MPEA NP is a single-phase solid solution, having a substantially uniform nanoparticle size and a substantially uniform elemental distribution throughout the MPEA nanoparticle. The MPEA NPs have an increased specific surface area, relative to Pt NPs, and also exhibit enhanced catalytic activity for electrochemical oxygen reduction reactions.

In some embodiments of the second aspect, a multi-principal element alloy (MPEA) nanoparticle is described, said MPEA nanoparticle consisting essentially of or consisting of, Pt, Fe, Co, Ni, and Cu. In some embodiments, the MPEA nanoparticle comprises at least 20 mol % Pt, relative to the total number of moles of metals in the MPEA nanoparticle. In some embodiments, the MPEA nanoparticle comprises at least at least 33 mol % or 40 mol % or 50 mol % or 60 mol % Pt, relative to the total number of moles of metals in the MPEA nanoparticle. In some embodiments, the remaining mol % of the Fe, Co, Ni, and Cu in the MPEA is distributed substantially equally. In some embodiments, the remaining mol % of the Fe, Co, Ni, and Cu in the MPEA are not distributed equally. In one embodiment, the MPEA nanoparticle comprises Pt₄FeCoNiCu. The MPEA NP is a single-phase solid solution, having a substantially uniform nanoparticle size and a substantially uniform elemental distribution throughout the MPEA nanoparticle. The MPEA NPs have an increased specific surface area, relative to Pt NPs, and also exhibit enhanced catalytic activity for electrochemical oxygen reduction reactions.

In some embodiments of the second aspect, a multi-principal element alloy (MPEA) nanoparticle is described, said MPEA nanoparticle consisting essentially of or consisting of, Pt, Fe, Co, Ni, Cu, and Ir. In some embodiments, the MPEA nanoparticle comprises at least 20 mol % Pt, relative to the total number of moles of metals in the MPEA nanoparticle. In some embodiments, the MPEA nanoparticle comprises at least at least 33 mol % or 40 mol % or 50 mol % or 60 mol % Pt, relative to the total number of moles of metals in the MPEA nanoparticle. In some embodiments, the remaining mol % of the Fe, Co, Ni, Cu, and Ir in the MPEA is distributed substantially equally. In some embodiments, the remaining mol % of the Fe, Co, Ni, Cu, and Ir in the MPEA are not distributed equally. In one embodiment, the MPEA nanoparticle comprises Pt₅IrFeCoNiCu. The MPEA NP is a single-phase solid solution, having a substantially uniform nanoparticle size and a substantially uniform elemental distribution throughout the MPEA nanoparticle. The MPEA NPs have an increased specific surface area, relative to Pt NPs, and also exhibit enhanced catalytic activity for electrochemical oxygen reduction reactions.

In some embodiments, the MPEA nanoparticle of the second aspect is synthesized using the method of the first aspect, as described herein. In some embodiments, the elemental distribution of each of the elements is substantially uniform throughout the MPEA nanoparticle.

In one embodiment of the third aspect, a catalyst material for a fuel cell or a water electrolyzer is described, comprising a multi-component system including at least one MPEA nanoparticle as described herein in the second aspect or produced using the method of the first aspect, and a conductive carbon-containing carrier material, wherein the MPEA nanoparticle is mixed with the conductive carbon-containing carrier material or directly or indirectly arranged or supported on the carbon-containing carrier material. In some embodiments, the conductive carbon-containing carrier material is selected from carbon black, graphene, graphite, activated carbon, carbon fibers, fullerene, nanostructured carbon, carbon nanotubes and/or a carbonized carrier particle. In some embodiments, the conductive carbon-containing carrier material is modified by oxygen, nitrogen and/or phosphorus. The modified carbon-containing carrier materials have better electrocatalytic activity with respect to oxygen evolution reactions (OER) and ORR and better stability in the relevant potential range of 0.6 V to 1.9 V, measured with respect to a reversible hydrogen electrode (RHE). In some embodiments, the catalyst material is prepared as a catalyst ink which is formed/applied on a substrate. Catalyst inks are well known in the art. In some embodiments, a catalyst ink is prepared by dissolving 1 mg of catalyst (e.g., an MPEA described herein) in 1 mL of 10% IPA/90% deionized water and 10 μL Nafion solution.

Additional uses for the MPEA NPs described herein include, but are not limited to, heterogeneous catalysis, e.g., propane dehydrogenation (PDH).

In a fourth aspect, an electrode is described, for example, an oxygen electrode, for a fuel cell or a water electrolyzer, including a catalyst material described in the third aspect.

In a fifth aspect, a fuel cell, a water electrolyzer, a regenerative fuel cell, or a reversible water electrolyzer is described, wherein the fuel cell, a water electrolyzer, a regenerative fuel cell, or reversible water electrolyzer comprise an ion exchange membrane which is coated on at least on one side with a catalyst material described in the third aspect.

It is understood that the foregoing detailed description and accompanying examples are merely illustrative and are not to be taken as limitations upon the scope of the disclosure, which is defined solely by the appended claims and their equivalents.

### EXAMPLE

Here we report on the synthesis of MPEA nanoparticles in organic solutions. The nanoparticles are characterized by scanning transmission electron microscopy (STEM)-based imaging and elemental mapping. The obtained Pt₄FeCoNiCu and Pt₅IrFeCoNiCu NPs are further subjected to electrochemical studies for demonstration of the oxygen reduction reaction catalytic application.

### Chemicals and Materials

All chemicals were used without any further purification. Platinum (II) acetylacetonate (Pt(acac)₂), iridium (III) acetylacetonate (Ir(acac)₃), iron (III) acetylacetonate (Fe(acac)₃), cobalt (II) acetylacetonate (Co(acac)₂), nickel (II) acetylacetonate (Ni(acac)₂), copper (II) acetylacetonate (Cu(acac)₂), Oleylamine (OAm) (70%), and Borane-tert-Butylamine complex (BTB) were purchased from Sigma-Aldrich.

### Nanoparticle Synthesis

To prepare a Pt-based MPEA nanoparticle having the formula Pt₅IrFeCoNiCu, a combination of 0.2 mmol of Pt(acac)₂, 0.04 mmol of Ir(acac)₃, 0.04 mmol of Fe(acac)₃, 0.04 mmol of Co(acac)₂, 0.04 mmol of Ni(acac)₂, and 0.04 mmol of Cu(acac)₂ were dissolved in 20 mL of OAm and the solution was heated to 120° C. under an Ar environment. After maintaining the temperature at 120° C. for 30 min, 50 mg of the reducing agent BTB dissolved in 1 ml OAm was injected into the reaction for the reduction of the metal precursor. After that, the temperature was further raised to 300° C. at 5° C./min. The reaction was kept at 300° C. for 60 minutes to guarantee the complete reduction of the precursor. The mixture was cooled to room temperature and mixed with ethanol, followed by centrifugation of the solution at 8000 rpm for 5 min. The obtained product (Pt₅IrFeCoNiCu MPEA nanoparticles) was further washed with a mixture of hexane and ethanol twice and then dispersed in hexane.

To prepare a Pt-based MPEA nanoparticle having the formula Pt₄FeCoNiCu was also prepared wherein 0.16 mmol of Pt(acac)₂, 0.04 mmol of Fe(acac)₃, 0.04 mmol of Co(acac)₂, 0.04 mmol of Ni(acac)₂, and 0.04 mmol of Cu(acac)₂ were dissolved in 20 mL of OAm and the solution was heated to 120° C. under an Ar environment. After maintaining the temperature at 120° C. for 30 min, 50 mg of the reducing agent BTB dissolved in 1 ml OAm was injected into the reaction for the reduction of the metal precursor. After that, the temperature was further raised to 300° C. at 5° C./min. The reaction was kept at 300° C. for 60 minutes to guarantee the complete reduction of the precursor. The mixture was cooled to room temperature and mixed with ethanol, followed by centrifugation of the solution at 8000 rpm for 5 min. The obtained product (Pt₄FeCoNiCu MPEA nanoparticles) was further washed with a mixture of hexane and ethanol twice and then dispersed in hexane.

### Preparation of Carbon-Supported Catalyst

The as-prepared MPEA nanoparticles in hexane were mixed with a certain amount of pre-dispersed carbon in toluene. The mixture was sonicated for 1 hour and then centrifuged and washed with hexane three times. The catalyst was collected after complete drying under vacuum.

### Characterization

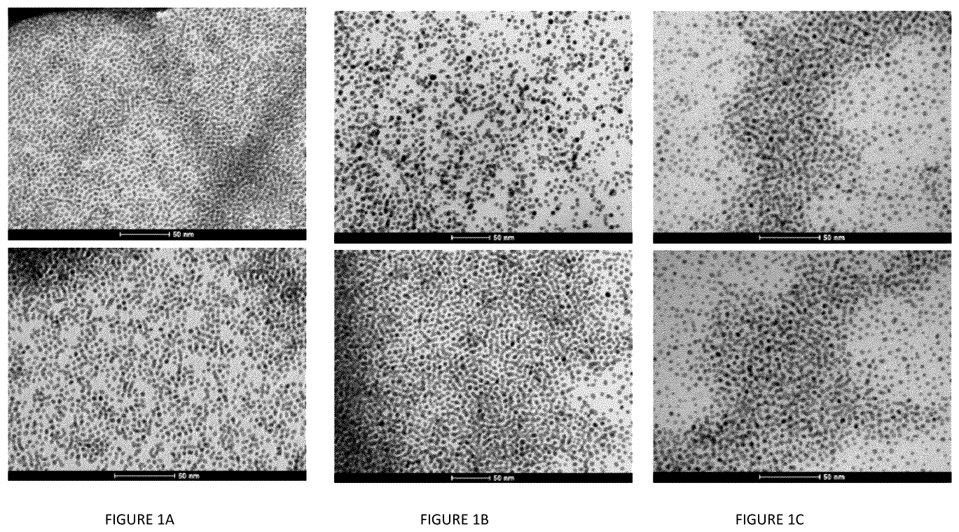

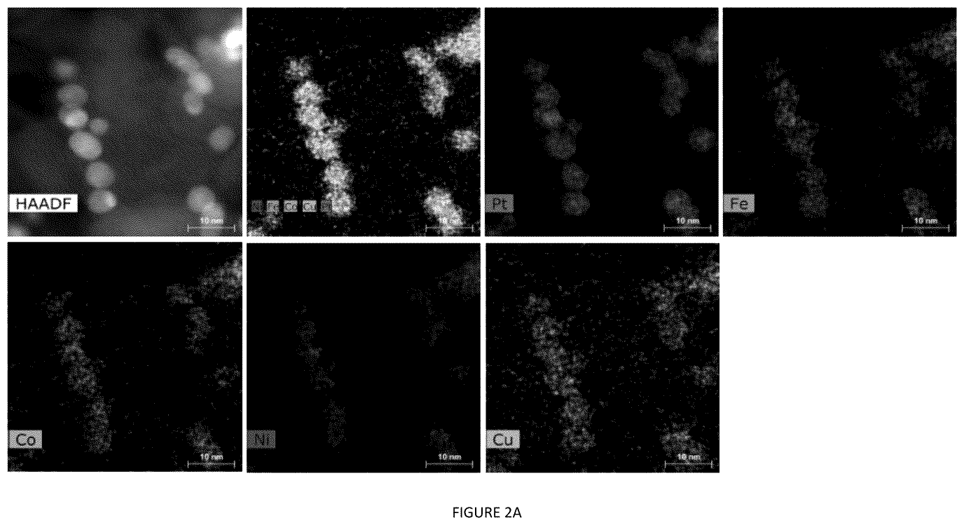

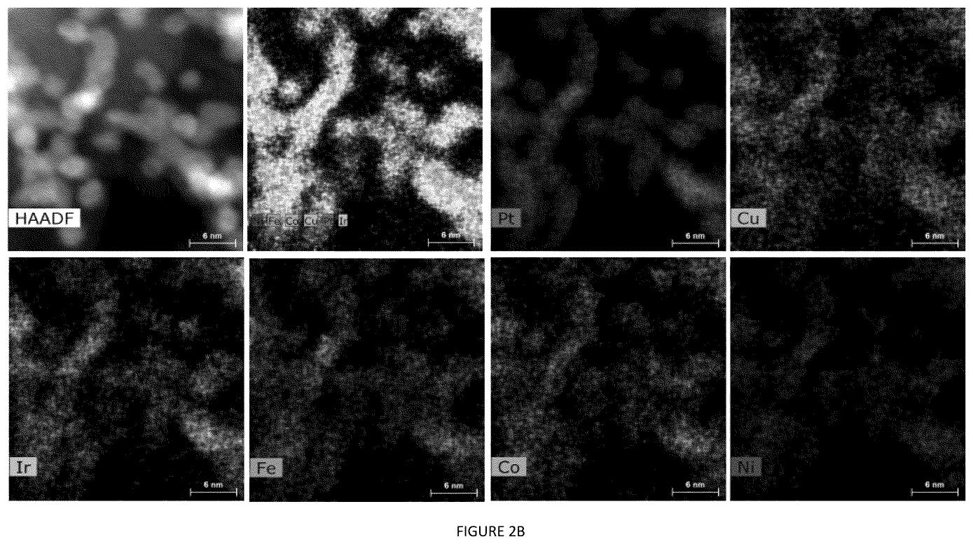

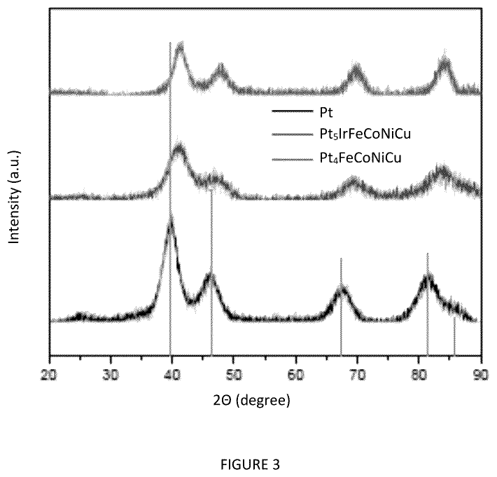

The obtained nanoparticles (NPs) had an overall diameter of ˜5 nm (FIGS. 1B and 1C, corresponding to Pt₄FeCoNiCu and Pt₅IrFeCoNiCu, respectively), with most of the lattice structure exhibited using high-resolution transmission electron microscopy (HRTEM), wherein the images correspond to the (111) planes of face-centered cubic (fcc) Pt (FIG. 1A). The energy dispersive spectroscopy (EDS) elemental mapping profiles provide direct evidence of the successful preparation of Pt₄FeCoNiCu (FIG. 2A) and Pt₅IrFeCoNiCu (FIG. 2B) MPEA NPs. The x-ray diffraction (XRD) patterns (FIG. 3) reveal that both MPEAs have a fcc structure, which is similar to pure Pt. All the Pt (111) peaks in the MPEA samples showed a red shift when compared to the standard Pt (111), indicating compressive strain of the Pt. The Pt₄FeCoNiCu has the larger strain of 3.41%, which is calculated by Bragg's law, while the strain of Pt₅IrFeCoNiCu is 2.98%. The compressive strain of the MPEA NPs is slightly different because the lattice constant of Pt (0.3924 nm) is smaller than Ir (0.3839 nm), Fe (0.2867 nm), Co (0.2507 nm), Ni (0.3524 nm), and Cu (0.3615 nm).

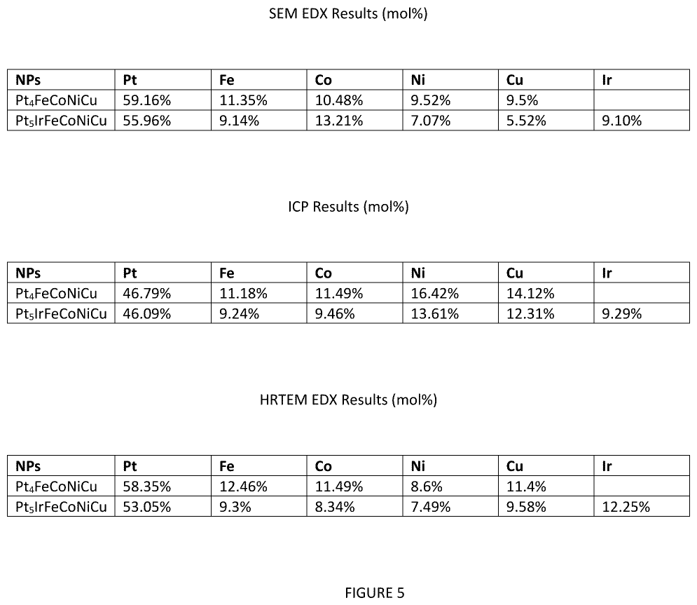

The percentage of each metal in the MPEA NPs was determined using STEM EDX, inductively coupled plasma (ICP) spectroscopy, and HRTEM EDX, as shown in FIG. 5. It can be seen that the product composition (in mol %) is very close to the reactant precursors' ratio.

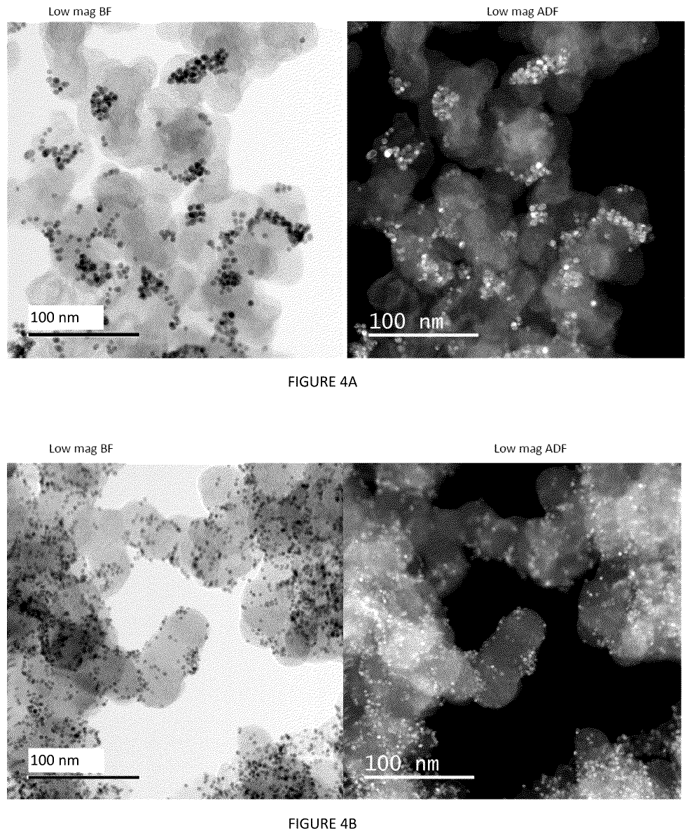

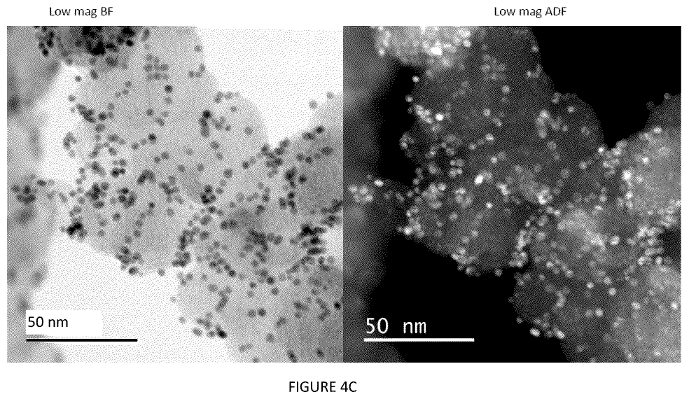

The as-prepared MPEA nanoparticles on a carbon substrate are shown in FIGS. 4A-4C, wherein images were obtained using bright field (BF) scanning transmission electron microscopy (STEM) and annular dark field (ADF) STEM. FIG. 4Ashows the lower magnification images for Pt₄FeCoNiCu MPEA NPs and FIGS. 4C-4D show the lower and higher magnification images for Pt₅IrFeCoNiCu MPEA NPs. Advantageously, it can be seen that there is a substantially uniform dispersion of the MPEA NPs throughout the carbon substrate.

Various changes and modifications to the disclosed embodiments will be apparent to those skilled in the art. Such changes and modifications, including without limitation those relating to the chemical structures, substituents, derivatives, intermediates, syntheses, compositions, formulations, or methods of use of the disclosure, may be made without departing from the spirit and scope thereof.

### REFERENCES

1. Yao, Y. G.; Huang, Z. N.; Li, T. Y.; Wang, H.; Liu, Y. F.; Stein, H. S.; Mao, Y. M.; Gao, J. L.; Jiao, M. L.; Dong, Q.; Dai, J. Q.; Xie, P. F.; Xie, H.; Lacey, S. D.; Takeuchi, I.; Gregoire, J. M.; Jiang, R. Z.; Wang, C.; Taylor, A. D.; Shahbazian-Yassar, R.; Hu, L. B., High-throughput, combinatorial synthesis of multimetallic nanoclusters. P Natl Acad Sci USA 2020, 117 (12), 6316-6322.
2. Liu, M.; Zhang, Z.; Okejiri, F.; Yang, S.; Zhou, S.; Dai, S., Entropy-Maximized Synthesis of Multimetallic Nanoparticle Catalysts via a Ultrasonication-Assisted Wet Chemistry Method under Ambient Conditions. Advanced Materials Interfaces 2019, 6 (7), 1900015.
3. Yao, Y. G.; Huang, Z. N.; Xie, P. F.; Lacey, S. D.; Jacob, R. J.; Xie, H.; Chen, F. J.; Nie, A. M.; Pu, T. C.; Rehwoldt, M.; Yu, D. W.; Zachariah, M. R.; Wang, C.; Shahbazian-Yassar, R.; Li, J.; Hu, L. B., Carbothermal shock synthesis of high-entropy-alloy nanoparticles. Science 2018, 359 (6383), 1489-1494.
4. Xie, P. F.; Yao, Y. G.; Huang, Z. N.; Liu, Z. Y.; Zhang, J. L.; Li, T. Y.; Wang, G. F.; Shahbazian-Yassar, R.; Hu, L. B.; Wang, C., Highly efficient decomposition of ammonia using high-entropy alloy catalysts. Nat Commun 2019, 10.
5. Glasscott, M. W.; Pendergast, A. D.; Goines, S.; Bishop, A. R.; Hoang, A. T.; Renault, C.; Dick, J. E., Electrosynthesis of high-entropy metallic glass nanoparticles for designer, multi-functional electrocatalysis (vol 10, 2650, 2019). Nat Commun 2019, 10.

1. A method of synthesizing multi-principal element alloy (MPEA) nanoparticles (NPs), said method comprising:
combining at least four metal ion-containing compounds in at least one first solvent and heating to a first temperature in a range from about 100° C. to about 150° C. in an inert environment for time effective to dissolve the metal ion-containing compounds in the first solvent to produce a mixture comprising metal ions;
adding at least one reducing agent to the mixture and heating to a second temperature in a range from about 250° C. to about 350° C. for time effective to substantially complete reduction of the metal ions; and
cooling to a third temperature in a range from about 15° C. to about 25° C. and mixing with at least one second solvent to obtain a mixture comprising the MPEA NPs,
wherein the at least four metal ion-containing compounds comprise an element selected from the group consisting of Pt, Ti, V, Cr, Mn, Fe, Co, Ni, Cu, Zn, Zr, Nb, Mo, Tc, Ru, Rh, Pd, Ag, Cd, Hf, Ta, W, Re, Os, Ir, and Au.

2. The method of claim 1, wherein the at least four metal ion-containing compounds are selected from the group consisting of a platinum ion-containing compound, an iron ion-containing compound, a cobalt ion-containing compound, a nickel ion-containing compound, a copper ion-containing compound, and an iridium ion-containing compound.

3. (canceled)

4. The method of claim 1, wherein the at least one first solvent comprises a long-chain alkylamine selected from the group consisting of olelyamine, octadecylamine, hexadecylamine, linoleylamine, arachidonoyl amine, and methylarachidonoyl amine.

5. (canceled)

6. The method of claim 1, wherein the at least one reducing agent comprises a species selected from the group consisting of borane tert-butylamine complex (BTB), ascorbic acid, n-butyl lithium, super hydride solution, NaBH4, carbon monoxide, hydrogen gas, and carbonyl chemicals.

7. The method of claim 1, wherein the at least one second solvent comprises tetramethylene sulfone, benzyl ether, 1-octadecene, dichlorobenzene, trichlorobenzene, methanol, ethanol, 1-propanol, 2-propanol, 1-butanol, 2-butanol, t-butanol, 1-pentanol, hexanol, ethylene glycol, propylene glycol (1,2-propanediol), tetramethylene glycol (1,4-butanediol), neopentyl glycol, diethylene glycol monomethyl ether, triethylene glycol monomethyl ether, diethylene glycol monoethyl ether, triethylene glycol monoethyl ether, ethylene glycol monopropyl ether, ethylene glycol monobutyl ether, diethylene glycol monobutyl ether, triethylene glycol monobutyl ether, propylene glycol methyl ether, dipropylene glycol methyl ether, tripropylene glycol methyl ether, propylene glycol n-propyl ether, dipropylene glycol n-propyl ether, tripropylene glycol n-propyl ether, propylene glycol n-butyl ether, dipropylene glycol n-butyl ether, tripropylene glycol n-butyl ether, dimethylacetamide; formamide, dimethylformamide, 1-methyl-2-pyrrolidinone, dimethyl sulfoxide, and any combination thereof.

8. The method of claim 1, wherein the at least four metal ion-containing compounds each comprise an anion selected from the group consisting of fluoride, chloride, bromide, iodide, nitrite, nitrate, sulfite, sulfate, chlorite, chlorate, cyanide, hydroxide, oxide, sulfide, phosphate, acetate, carbonate, bicarbonate, nitride, oxalate, ethylenediamine tetraacetate, thiocyanate, acetylacetonate, catecholate, cyclopentadienyl, dimethylglyoximate, glycinate, and carbonyl.

9.-10. (canceled)

11. The method of claim 1, wherein at least one metal-ion containing compound comprises at least one non-precious metal.

12. The method of claim 1, wherein at least 20 mol % of a Pt-containing compound, relative to the total number of moles of metal-ion containing compounds, is dissolved in the first solvent.

13.-15. (canceled)

16. The method of claim 1, further comprising separating the synthesized MPEA nanoparticles from the second solvent and washing the synthesized MPEA nanoparticles using a washing solution.

17. The method of claim 1, wherein the MPEA nanoparticle synthesized comprises Pt₄FeCoNiCu.

18. The method of claim 1, wherein the MPEA nanoparticle synthesized comprises Pt₅IrFeCoNiCu.

19. A multi-principal element alloy (MPEA) nanoparticle comprising four or more elements selected from the group consisting of Pt, Ti, V, Cr, Mn, Fe, Co, Ni, Cu, Zn, Zr, Nb, Mo, Tc, Ru, Rh, Pd, Ag, Cd, Hf, Ta, W, Re, Os, Ir, and Au.

20. The MPEA nanoparticle of claim 19 comprising four or more elements selected from the group consisting of Pt, Fe, Co, Ni, Cu, and Ir.

21. (canceled)

22. The MPEA nanoparticle of claim 19, comprising at least 20 mol % Pt, relative to the total number of moles of metals in the MPEA nanoparticle.

23.-24. (canceled)

25. The MPEA nanoparticle of claim 19, wherein the MPEA nanoparticles are a single-phase solid solution.

26.-27. (canceled)

28. The MPEA nanoparticle of claim 19, wherein the MPEA nanoparticles comprise Pt₄FeCoNiCu.

29. The MPEA nanoparticle of claim 19, wherein the MPEA nanoparticles comprise Pt₅IrFeCoNiCu.

30. (canceled)

31. A catalyst material comprising an MPEA nanoparticle of claim 19.

32. The catalyst material of claim 31, further comprising a conductive carbon-containing carrier material selected from the group consisting of carbon black, graphene, graphite, activated carbon, carbon fibers, fullerene, nanostructured carbon, carbon nanotubes, a carbonized carrier particle, and combinations thereof.

33. (canceled)

34. An electrode for a fuel cell or a water electrolyzer, including the catalyst material of claim 31.

35. (canceled)
